(19) United States
(12) Patent Application Publication
(10) Pub. No.: US 2019/0027741 A1
(43) Pub. Date: Jan. 24, 2019

(54) POSITIVE ELECTRODE ACTIVE MATERIAL FOR LITHIUM SECONDARY CELL, POSITIVE ELECTRODE FOR LITHIUM SECONDARY CELL, LITHIUM SECONDARY CELL AND METHODS FOR PRODUCING THESE

(71) Applicant: NEC CORPORATION, Tokyo (JP)

(72) Inventors: Katsumi MAEDA, Tokyo (JP); Sadanori HATTORI, Tokyo (JP)

(73) Assignee: NEC CORPORATION, Tokyo (JP)

(21) Appl. No.: 16/070,984

(22) PCT Filed: Dec. 19, 2016
(86) PCT No.: PCT/JP2016/087806

§ 371 Date: Jul. 18, 2018

(30) Foreign Application Priority Data
Jan. 19, 2016 (JP) 2016-007743

(51) Int. Cl. H01M 4/36; H01M 10/0525; H01M 4/505; H01M 4/525; H01M 4/62; H01M 10/42; H01M 10/0585

(52) U.S. Cl. CPC H01M 4/366; H01M 10/0525; H01M 4/505; H01M 2004/028; H01M 4/628; H01M 10/4235; H01M 10/0585; H01M 4/525

(57) ABSTRACT

Provided are a positive electrode active material capable of inhibiting generation of gases accompanied by charging/discharging, a positive electrode and a lithium secondary cell using the positive electrode active material, and methods for manufacturing the positive electrode active material, the positive electrode, and the lithium secondary cell. The positive electrode active material comprises a coated positive electrode active material having a coating comprising at least one selected from specific phosphonic esters and specific phosphorous triesters.

### TECHNICAL FIELD

The present invention relates to a positive electrode active material, for a lithium secondary cell, suppressing generation of gases associated with charge and discharge and suppressing the decrease in the capacity of the cell, a positive electrode, for a lithium secondary cell, using the positive electrode active material, a lithium secondary cell using the positive electrode, and methods for producing these.

### BACKGROUND ART

Lithium secondary cells are, due to advantages of high energy density, low self-discharge, excellent long-term reliability and the like, utilized as batteries for small-size electronic devices such as laptop computers, cell phones, and the like. Further in recent years, there have advanced the applications of lithium secondary cells to uses in storage batteries for electric cars and households and power storage.

Usual lithium secondary cells are configured such that a positive electrode and a negative electrode, each in which an active material layer containing an active material is formed on a current collector, are made to face each other and laminated through a separator, and as required, a plurality thereof are laminated to make a laminate; and these are soaked in a nonaqueous electrolytic solution. As positive electrode active materials of such lithium secondary cells, in order to achieve high-energy density lithium secondary cells, there are disclosed a lithium metal composite oxide having a layered rock salt structure represented by Li_{1.19}Mn_{0.52}Fe_{0.22}O_{1.98} (Patent Literature 1) and a lithium metal composite oxide represented by LiNi_{0.5}Mn_{1.5}O₄ (Patent Literature 2).

In such lithium secondary cells, upon charge and discharge, the reductive decomposition of an electrolytic solution solvent occurs on the negative electrode surface, the oxidative decomposition of the electrolytic solution solvent occurs on the positive electrode surface, and the decomposition products deposit on the electrode surfaces and increase the resistance, and in some cases, gases generated by the decomposition of the solvent make the cells swell. As a result, there arises the problem of decreases in cell characteristics due to decreases in storage characteristics of the cells and decreases in cycle characteristics of the lithium secondary cells.

In order to avoid such a problem, it is known that compounds having a protective film-forming function, such as vinylene carbonate, fluoroethylene carbonate and maleic anhydride, are added to an electrolytic solution; these compounds are intentionally decomposed at the initial charge time; and the decomposed substances form a protective film, SEI (Solid Electrolyte Interface), on the electrode surface to thereby suppress the decomposition of the solvent (Non Patent Literature 1).

Although these additives form SEI on the negative electrode surface, however, there is not attained a sufficient effect on suppression of gas generation due to oxidative decomposition of the solvent on the positive electrode.

Particularly high-potential lithium secondary cells using a positive electrode active material having a potential of 4.5 V or higher as seen from the above become more liable to cause gas generation due to oxidative decomposition of a solvent on a positive electrode than conventional usual lithium secondary cells having a voltage of 3.5 to 4.2 V.

There are disclosed a method, as a method of forming a protective film on the positive electrode active material surface and thereby suppressing gas generation from the positive electrode, in which the positive electrode active material is coated with a silane coupling agent and an epoxy resin (Patent Literature 3), and a method in which a boric acid compound is attached (Patent Literature 4). However, a problem thereof is that these positive electrode protective films, in lithium secondary batteries using a high potential positive electrode of 4.5 V or higher, cannot suppress the decomposition of the electrolytic solution on the positive electrodes associated with charge and discharge, and cannot sufficiently suppress gas generation.

Besides, there is disclosed a positive electrode in which when a positive electrode active material layer is formed by using a positive electrode mixture slurry prepared by mixing a positive electrode active material containing a lithium composite oxide with phosphorous acid, by varying distributions of a binder and an electroconductive auxiliary agent in the positive electrode active material layer and making the volume density of the positive electrode active material in a specific range, damages in the pressing time during and after winding can be suppressed (Patent Literature 5); and there is disclosed a lithium secondary cell in which by incorporating trimethyl phosphite and dimethyl phosphite in an electrolytic solution, the flame retardancy of the electrolytic solution is improved; and the formation of dendrite on an overcharged negative electrode, and the flowing of a large current when a positive electrode and a negative electrode are short-circuited can be suppressed (Patent Literature 6).

### CITATION LIST

### Patent Literature

Patent Literature 1: JP2013-254605A
Patent Literature 2: WO2012/141301
Patent Literature 3: JP2014-22276A
Patent Literature 4: JP2010-40382A
Patent Literature 5: JP2012-160463A
Patent Literature 6: JP2015-022952A

### Non Patent Literature

Non Patent Literature 1: Journal. Power Sources, Vol. 162, No. 2, p. 1379-1394 (2006)

### SUMMARY OF INVENTION

### Technical Problem

An object of the present invention is to provide a positive electrode active material capable of suppressing gas generation associated with charge and discharge in a lithium secondary cell, particularly in cases where the use voltage of the lithium secondary cell is high, capable of suppressing gas generation associated with charge and discharge, a positive electrode and a lithium secondary cell using the positive electrode active material, and methods for producing these.

### Solution to Problem

The positive electrode active material for a lithium secondary cell according to the present invention comprises a coated positive electrode active material having a coating comprising at least one selected from phosphonic esters represented by the formula (1):

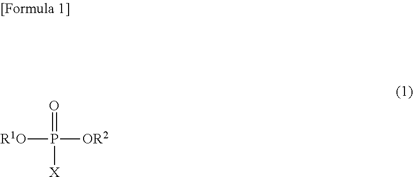

wherein R¹ and R² independently denote a substituted or nonsubstituted alkyl group having 1 to 18 carbon atoms, or a substituted or nonsubstituted aryl group; and X denotes a hydrogen atom or an alkyl group,
and phosphorous triesters represented by the formula (2):

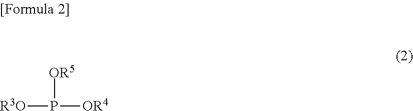

wherein R³ to R⁵ independently denote a substituted or nonsubstituted alkyl group having 1 to 18 carbon atoms, or a substituted or nonsubstituted aryl group.

Further the lithium secondary cell according to the present invention comprises the positive electrode for a lithium secondary cell, a negative electrode comprising a negative electrode active substance capable of intercalating and deintercalating lithium ions, and an electrolytic solution penetrating these electrodes.

Further the positive electrode for a lithium secondary cell according to the present invention has a positive electrode active material layer comprising the positive electrode active material for a lithium secondary cell on a positive electrode current collector; and the lithium secondary cell according to the present invention comprises the positive electrode for a lithium secondary cell, a negative electrode comprising a negative electrode active substance, an electrolytic solution penetrating these electrodes, and an outer package accommodating these.

Further the method for producing a positive electrode active material for a lithium secondary cell according to the present invention comprises soaking a positive electrode active material in a coating-forming liquid comprising at least one selected from phosphonic esters represented by the formula (1):

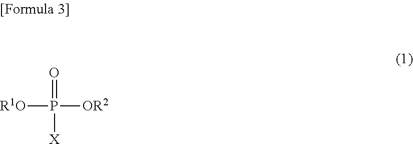

wherein R¹ and R² independently denote a substituted or nonsubstituted alkyl group having 1 to 18 carbon atoms, or a substituted or nonsubstituted aryl group; and X denotes a hydrogen atom or an alkyl group,
and phosphorous triesters represented by the formula (2):

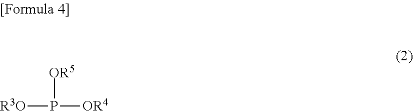

wherein R³ to R⁵ independently denote a substituted or nonsubstituted alkyl group having 1 to 18 carbon atoms, or a substituted or nonsubstituted aryl group,
to form a coating on at least a part of the positive electrode active material for the sake of forming a coated positive electrode active material.

Further the method for producing a positive electrode for a lithium secondary cell according to the present invention comprises: preparing a positive electrode active material layer-forming liquid comprising the positive electrode active material for a lithium secondary cell obtained by the above method for producing a positive electrode active material for a lithium secondary cell, and a positive electrode binder; and forming a positive electrode active material layer on a positive electrode current collector by using the positive electrode active material layer-forming liquid.

Further the method for producing a positive electrode for a lithium secondary battery according to the present invention comprises: preparing a positive electrode active material layer-forming liquid comprising a positive electrode active material, a positive electrode binder, and at least one selected from phosphonic esters represented by the formula (1):

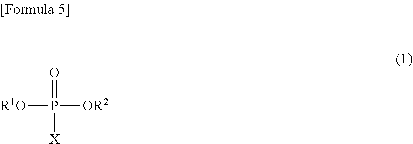

wherein R¹ and R² independently denote a substituted or nonsubstituted alkyl group having 1 to 18 carbon atoms, or a substituted or nonsubstituted aryl group; and X denotes a hydrogen atom or an alkyl group, and phosphite triesters represented by the formula (2):

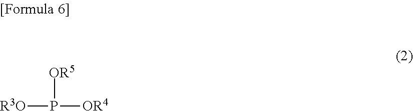

wherein R³ to R⁵ independently denote a substituted or nonsubstituted alkyl group having 1 to 18 carbon atoms, or a substituted or nonsubstituted aryl group;
and forming a positive electrode active material layer on a positive electrode current collector by using the positive electrode active material layer-forming liquid.

Further the method for producing a lithium secondary cell according to the present invention comprises: forming a positive electrode active material layer comprising a positive electrode active material and a positive electrode binder on a positive electrode current collector; soaking the positive electrode active material layer in a coating-forming liquid comprising at least one selected from phosphonic esters represented by the formula (1):

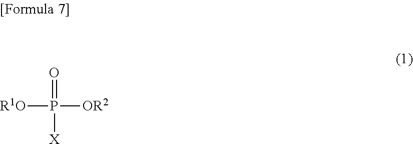

wherein R¹ and R² independently denote a substituted or nonsubstituted alkyl group having 1 to 18 carbon atoms, or a substituted or nonsubstituted aryl group; and X denotes a hydrogen atom or an alkyl group,
and phosphorous triesters represented by the formula (2):

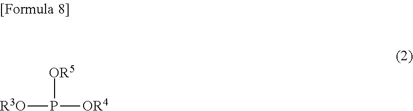

wherein R³ to R⁵ independently denote a substituted or nonsubstituted alkyl group having 1 to 18 carbon atoms, or a substituted or nonsubstituted aryl group;
or applying the coating-forming liquid onto the positive electrode active material layer to form a coating on at least a part of the positive electrode active material for the sake of forming a coated positive electrode active material.

Further the method for producing a lithium secondary cell according to the present invention comprises: packing, in an outer package, a positive electrode comprising a positive electrode active material, a negative electrode comprising a negative electrode active material, a separator, and an electrolytic solution containing 0.05% by weight to 10% by weight of at least one selected from phosphonic esters represented by the formula (1):

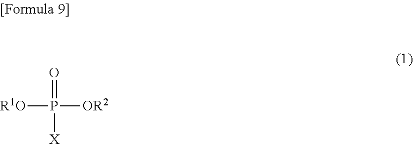

wherein R¹ and R² independently denote a substituted or nonsubstituted alkyl group having 1 to 18 carbon atoms, or a substituted or nonsubstituted aryl group; and X denotes a hydrogen atom or an alkyl group,
and phosphorous triesters represented by the formula (2):

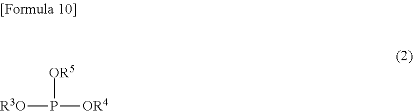

wherein R³ to R⁵ independently denote a substituted or nonsubstituted alkyl group having 1 to 18 carbon atoms, or a substituted or nonsubstituted aryl group;
sealing the outer package to form a sealed body; and thereafter, before an activation treatment, leaving the sealed body at room temperature to 80° C. to form a coating originated from the phosphonic ester represented by the formula (1) or the phosphorous triester represented by the formula (2) on at least a part of the surface of the positive electrode active material.

### Advantageous Effects of Invention

The positive electrode active material for a lithium secondary cell and the positive electrode for a lithium secondary cell and the lithium secondary cell using the positive electrode active material, since comprising a coated positive electrode active material having a coating of a specific phosphonic ester or a specific phosphorous triester, even in the case where the use voltage of the lithium cell is set at a high potential, can suppress the oxidative decomposition of a solvent at the positive electrode and suppress the gas generation.

### BRIEF DESCRIPTION OF DRAWING

FIG. 1 is a schematic cross-sectional view illustrating a constitution of one example of the lithium secondary cell according to the present invention.

### DESCRIPTION OF EMBODIMENTS

### [Positive Electrode Active Material for a Lithium Secondary Cell]

The positive electrode active material for a lithium secondary cell according to the present invention suffices if comprising a coated positive electrode active material having a coating comprising at least one selected from phosphonic esters represented by the formula (1):

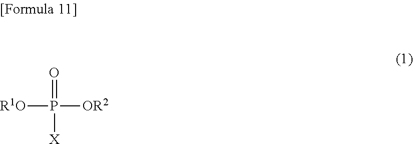

wherein R¹ and R² independently denote a substituted or nonsubstituted alkyl group having 1 to 18 carbon atoms, or a substituted or nonsubstituted aryl group; and X denotes a hydrogen atom or an alkyl group,
and phosphorous triesters represented by the formula (2):

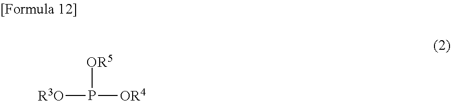

wherein R³ to R⁵ independently denote a substituted or nonsubstituted alkyl group having 1 to 18 carbon atoms, or a substituted or nonsubstituted aryl group.

The positive electrode active material is not especially limited, but is preferably one whose operation voltage is 4.2 V or higher, and specifically includes, as suitable ones, lithium transition metal oxides such as LiMnO₂, LiₓMn₂O₄ (0<x<2) such as LiMn₂O₄, LiCoO₂ or LiNiO₂, lithium transition metal composite oxides, being oxides of lithium and two or more transition metals, such as LiCo₁₋ₓNiₓO₂ (0.01<x<1), LiNiₓCo_{y}Mn_{z}O₂ (x+y+z=1) or LiNi_{0.5}Mn_{1.5}O₄, or phosphoric acid compounds having an olivine structure, such as LiFePO₄. These can be used singly or in combinations of two or more.

Among these, the positive electrode active material usable for a lithium secondary cell having a use voltage of 4.5 V or higher prefers lithium transition metal composite oxides composed of lithium and a plurality of transition metals selected from cobalt, manganese and nickel and particularly the lithium transition metal composite oxides having a spinel structure, such as LiNi_{0.5}Mn_{1.5}O₄, having an operation voltage of 4.8 V or higher can suitably be used.

Further, excess-lithium transition metal composite oxides in which in these lithium transition metal composite oxides, Li is made excessive to stoichiometric compositions can also be used in lithium secondary cells having a high potential of 4.5 V or higher. The excess-lithium transition metal composite oxides particularize:

Li₁₊ₐNiₓMn_{y}O₂ (0<a≤0.5,0<x<1,0<y<1),

Li₁₊ₐNiₓMn_{y}M_{z}O₂ (0<a≤0.5,0<x<1,0<y<1,0<z<1, and M is Co or Fe), and

Li_{α}Ni_{β}Co_{γ}Al_{δ}O₂ (1≤α≤1.2,β+γ+δ=1,β≤0.7,γ≤0.2).

Further in order to improve cycle characteristics and safety, and enable the use at a high charge potential, also a lithium transition metal composite oxide being obtained by replacing a part of the lithium transition metal composite oxide by other elements can also be used for high-potential lithium secondary cells. There can be used, for example, a lithium transition metal composite oxide being obtained by substituting a part of one or more of cobalt, manganese and nickel by at least one or more elements of Sn, Mg, Fe, Ti, Al, Zr, Cr, V, Ga, Ge, Zn, Sm, Cu, Bi, Mo, La and the like, a lithium transition metal composite oxide being obtained by substituting a part of oxygen by S or F, or a positive electrode in which the positive electrode surface is coated with an oxide containing these elements, such as SnO, MgO, TiO₂, Al₂O₃, ZrO, V₂O₅, Ga₂O₃, GeO₂, Sm₂O₃, ZnO, MoO₃, La₂O₃ or the like.

Specific examples of these lithium transition metal composite oxides include LiCo_{0.8}Ni_{0.2}O₂, LiNi_{1/2}Mn_{3/2}O₄, LiNi_{1/3}Co_{1/3}Mn_{1/3}O₂, LiNi_{0.4}Co_{0.3}Mn_{0.3}O₂ (abbreviated to NCM433), LiNi_{0.5}Co_{0.2}Mn_{0.3}O₂ (abbreviated to NCM523), LiNi_{0.5}Co_{0.3}Mn_{0.2}O₂ (abbreviated to NCM532), LiNi_{0.8}Co_{0.15}Al_{0.05}O₂, LiNi_{0.8}Co_{0.1}Mn_{0.1}O₂, Li_{1.2}Mn_{0.4}Ni_{0.4}O₂, Li_{1.2}Mn_{0.6}Ni_{0.2}O₂, Li_{1.19}Mn_{0.52}Fe_{0.22}O_{1.98}, Li_{1.21}Mn_{0.46}Fe_{0.15}Ni_{0.15}O₂, LiMn_{1.5}Ni_{0.5}O₄, Li_{1.2}Mn_{0.4}Fe_{0.4}O₂, Li_{1.21}Mn_{0.4}Fe_{0.2}Ni_{0.2}O₂, Li_{1.26}Mn_{0.37}Ni_{0.22}Ti_{0.15}O₂, LiMn_{1.37}Ni_{0.5}Ti_{0.13}O_{4.0}, Li_{1.2}Mn_{0.56}Ni_{0.17}Co_{0.07}O₂, Li_{1.2}Mn_{0.54}Ni_{0.13}Co_{0.13}O₂, Li_{1.2}Mn_{0.56}Ni_{0.17}Co_{0.07}O₂, Li_{1.2}Mn_{0.54}Ni_{0.13}Co_{0.13}O₂, LiNi_{0.8}Co_{0.15}Al_{0.05}O₂, LiNi_{0.5}Mn_{1.48}Al_{0.02}O₄, LiNi_{0.5}Mn_{1.45}Al_{0.05}O_{3.9}Fe_{0.05}, LiNi_{0.4}Co_{0.2}Mn_{1.25}Ti_{0.15}O₄, Li_{1.23}Fe_{0.15}Ni_{0.15}Mn_{0.46}O₂, Li_{1.26}Fe_{0.11}Ni_{0.11}Mn_{0.52}O₂, Li_{1.2}Fe_{0.20}Ni_{0.20}Mn_{0.40}O₂, Li_{1.29}Fe_{0.07}Ni_{0.14}Mn_{0.57}O₂, Li_{1.26}Fe_{0.22}Mn_{0.37}Ti_{0.15}O₂, Li_{1.29}Fe_{0.07}Ni_{0.07}Mn_{0.57}O_{2.8}, Li_{1.30}Fe_{0.04}Ni_{0.07}Mn_{0.61}O₂, Li_{1.2}Ni_{0.18}Mn_{0.54}Co_{0.08}O₂, Li_{1.23}Fe_{0.03}Ni_{0.03}Mn_{0.58}O₂.

These can be used singly or in combinations of two or more. Specifically, the lithium transition metal composite oxide can also be used by mixing NCM532 or NCM523 with NCM433 in the range of 9:1 to 1:9, for example, in 2:1. Further a cell having a high capacity and a high thermal stability can also be constituted, for example, by mixing a compound in which the content of Ni is high where x is 0.4 or lower in the formula (3) with a compound in which the content of Ni does not exceed 0.5, for example, NCM433, whose x is 0.5 or higher.

Formula: Li_{y}Ni₍₁₋ₓ₎MₓO₂ (3)

wherein 0≤x<1, 0<y≤1.2; M is at least one element selected from the group consisting of Co, Al, Mn, Fe, Ti and B.

[Coated Positive Electrode Active Material]

The coated positive electrode active material is the one in which at least a part of the positive electrode active material has a coating comprising at least one selected from phosphonic esters represented by the formula (1) and phosphorous triesters represented by the formula (2) (these may also be called phosphorous esters).

Although details are unclear as to chemical reactions and the like when the phosphonic ester or the phosphorous triester is coated on the positive electrode active material, it is conceivable, for example, in the case of the phosphonic ester, that as shown in the formula (4) (Mⁿ⁺ in the formula denotes a metal ion), the phosphonic ester reacts with hydroxyl groups present on the positive electrode active material surface to coat the positive electrode active material.

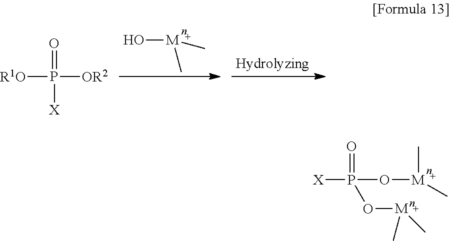

The phosphonic ester or the phosphorous triester, however, even if forming no chemical bond with the positive electrode active material, may physically adhere on the positive electrode active material.

When the positive electrode active material surface is coated with the phosphonic ester or the phosphorous triester, since the chemical reaction and the decomposition, associated with charge and discharge, of an electrolytic solution on the surface of the positive electrode active material are suppressed, the gas generation from the positive electrode is suppressed, attaining such effects that a lithium secondary cell has stability over a long period and the lifetime is prolonged. Consequently, there can be obtained a lithium ion secondary cell large in the capacity, high in the energy density and excellent in the stability of charge and discharge cycles.

In the formulae of the phosphonic ester represented by the formula (1) and the phosphorous triester represented by the formula (2), R¹ to R⁵ are independently a substituted or nonsubstituted alkyl group having 1 to 18 carbon atoms, or a substituted or nonsubstituted aryl group; and X is a hydrogen atom or an alkyl group.

Nonsubstituted alkyl groups having 1 to 18 carbon atoms represented by R¹ to R⁵ specifically are selected from a methyl group, an ethyl group, a propyl group, an isopropyl group, an n-butyl group, an isobutyl group, a t-butyl group, a pentyl group, an n-hexyl group, a 2-ethylhexyl group, an octyl group, a decyl group, a dodecyl group, a tridecyl group and an octadecyl group. In the alkyl group, one or more hydrogen atoms may be substituted, and the substituent is selected from a fluorine atom, an alkoxy group having 1 to 5 carbon atoms and an aryl group. These can independently become substituents of the alkyl group. The alkyl group having a substituent(s) specifically includes a trifluoromethyl group, a trifluoroethyl group, a pentafluoroethyl group, a heptafluoropropyl group and a benzyl group.

Then nonsubstituted aryl groups include a phenyl group and a naphthyl group. Substituents of the aryl group include the same substituents as in the above alkyl group, and the aryl group having a substituent(s) includes a tolyl group, a nonylphenyl group, a 4-fluorophenyl group and a pentafluorophenyl group.

Preferable examples of R¹ to R⁵ include a methyl group, an ethyl group, an isopropyl group, an n-butyl group, an isobutyl group, a 2-ethylhexyl group, an octyl group, a decyl group, a dodecyl group, an octadecyl group, a tridecyl group, a benzyl group, a phenyl group, a tolyl group and a nonylphenyl group.

The number of carbon atoms of the alkyl group represented by X is preferably 1 to 8, and the alkyl group may have substituents such as a fluorine atom. Specifically, the substituent is preferably a methyl group, an ethyl group, a propyl group, an isopropyl group, an n-butyl group, an isobutyl group, a t-butyl group, a pentyl group, an n-hexyl group, a 2-ethylhexyl group, an octyl group or the like.

Specific examples of the phosphonic ester and the phosphorous triester will be cited in Tables 1-1 to 1-3.

TABLE 1-1

| Name | Structural Formula |
|---|---|
| dimethyl phosphonate | 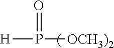 |
| diethyl phosphonate | 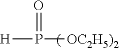 |
| diisopropyl phosphonate | 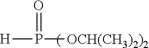 |
| dibutyl phosphonate | 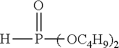 |
| diisobutyl phosphonate | 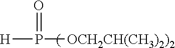 |
| di(2-ethylhexyl) phosphonate | 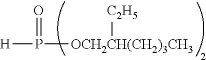 |
| didodecyl phosphonate | 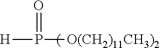 |
| dioctadecyl phosphonate | 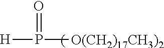 |
| diphenyl phosphonate | 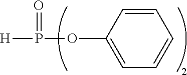 |
| dibenzyl phosphonate | 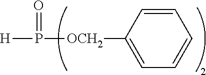 |
| diethyl ethylphosphonate | 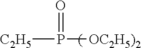 |
| diethyl methylphosphonate | 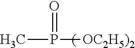 |

TABLE 1-2

| | |
|---|---|
| trimethyl phosphite | 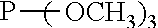 |
| triethyl phosphite | 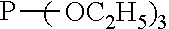 |
| triisopropyl phosphite | 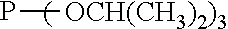 |
| tributyl phosphite | 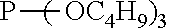 |
| trihexyl phosphite | 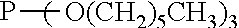 |
| tris(2-ethylhexyl) phosphite | 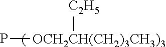 |
| trioctyl phosphite | 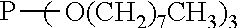 |
| tridecyl phosphite | 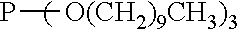 |
| tridodecyl phosphite | 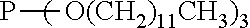 |
| tris(tridecyl) phosphite | 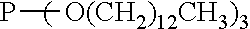 |
| trioctadecyl phosphite | 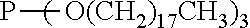 |
| triphenyl phosphite | 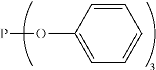 |
| tritolyl phosphite | 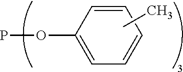 |
| tris(nonylphenyl) phosphite | 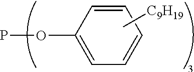 |

TABLE 1-3

| | |
|---|---|
| diphenyl (2-ethylhexyl) phosphite | 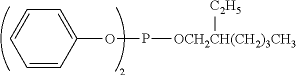 |
| diphenyl monodecyl phosphite | 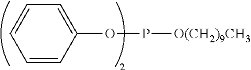 |
| diphenyl mono(tridecyl) phosphite | 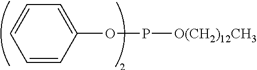 |

In the coated positive electrode active material formed by using such a phosphonic ester and a phosphorous triester, the amount of the phosphonic ester and phosphorous triester A is, with respect to that of the positive electrode active material B, in mass ratio (A/B), preferably 0.0005 to 0.5, and more preferably 0.001 to 0.3.

The density of the positive electrode active material layer is preferably 1.0 g/cm³ or higher and 3.0 g/cm³ or lower. When the density of the positive electrode active material layer is 1.0 g/cm³ or higher, lowering of the absolute value of the discharge capacity can be suppressed. On the other hand, when the density of the positive electrode active material layer is 3.0 g/cm³ or lower, lowering of the discharge capacity can be suppressed due to easy filtration of electrolytic solution into the electrodes.

[Method for Producing the Positive Electrode Active Material for a Lithium Secondary Cell]

Such a coated positive electrode active material can be prepared by soaking the positive electrode active material in a coating-forming liquid comprising the phosphonic ester or phosphorous triester and forming a coating on at least a part of the positive electrode active material. That is, a method for producing the positive electrode active material for a lithium secondary cell according to the present application is a method of soaking the positive electrode active material in a coating-forming liquid comprising the phosphonic ester or phosphorous triester to form a coating on at least a part of the positive electrode active material for the sake of forming a coated positive electrode active material.

The coating-forming liquid can be prepared by dissolving the phosphonic ester and phosphorous triester in a nonaqueous solvent of acyclic carbonates, acyclic esters, lactones, ethers, nitriles or the like.

Examples of the acyclic carbonate include dimethyl carbonate, diethyl carbonate, dipropyl carbonate and ethyl methyl carbonate. As the acyclic ester, there can be used, for example, methyl acetate, ethyl acetate, methyl propionate and ethyl propionate. Examples of the lactone include γ-butyrolactone, 6-valerolactone and α-methyl-γ-butyrolactone. Examples of the ether include tetrahydrofuran, 2-methyltetrahydrofuran, 1,3-dioxolane, 1,3-dioxane, 1,4-dioxane, 1,2-dimethoxyethane, 1,2-diethoxyethane and 1,2-dibutoxyethane. The nitrile includes acetonitrile and propionitrile.

The content of the phosphonic ester and phosphorous triester in the coating-forming liquid is preferably 0.01 to 15% by mass, and more preferably 0.05 to 10% by mass.

Then, the positive electrode active material is added to the coating-forming liquid, and soaked, for example, at room temperature to 80° C. for 1 hour to 24 hours. Thereafter, the positive electrode active material is filtered out and washed with a nonaqueous solvent, and thereafter dried at room temperature to 400° C. under vacuum or atmospheric pressure to obtain a coated positive electrode active material.

[Positive Electrode]

The positive electrode for a lithium secondary cell according to the present invention is one in which a positive electrode active material layer comprising the positive electrode active material for a lithium secondary cell is formed on a positive electrode current collector.

The positive electrode active material layer suffices if comprising the coated positive electrode active material, but for the purpose of reducing the impedance, a conductive auxiliary agent may be added. Examples of the conductive auxiliary agent include graphites such as natural graphite, artificial graphite and the like, and carbon blacks such as acetylene black, Ketjen black, furnace black, channel black and thermal black. The conductive auxiliary agent may be used by mixing a plurality of kinds thereof. The amount of the conductive auxiliary agent is preferably 1 to 10% by mass with respect to 100% by mass of the positive electrode active material.

It is preferable that the positive electrode active material layer be formed on the positive electrode current collector by unifying the coated positive electrode active material by using a positive electrode binder. Examples of a binder for the positive electrode include polyvinylidene fluoride, vinylidene fluoride-hexafluoropropylene copolymers, vinylidene fluoride-tetrafluoroethylene copolymers, styrene-butadiene copolymer rubber, polytetrafluoroethylene, polypropylene, polyethylene, polyimide, and polyamideimide. Particularly from the viewpoint of versatility and low costs, it is preferable to use a polyvinylidene fluoride as the binder for the positive electrode. The amount of the binder for the positive electrode is, from the viewpoint of the “sufficient binding capacity” and the “energy enhancement”, which are in a tradeoff relationship, with respect to 100 parts by mass of the positive electrode active material, preferably 2 to 10 parts by mass.

The positive electrode current collector is not especially limited, and for example, an aluminum foil, a stainless steel-made lath board or the like can be used.

[Method for Producing the Positive Electrode]

Methods for producing the positive electrode include a method of using a coated positive electrode active material in which a coating of the phosphonic ester or phosphorous triester is in advance formed, a method of forming a coated positive electrode active material simultaneously with the formation of the positive electrode by using a positive electrode active material not containing the coated positive electrode active material, and a method of forming a coated positive electrode active material after a positive electrode active material layer is formed by using a positive electrode active material not containing the coated positive electrode active material.

A method for producing a lithium secondary cell according to the present invention in the case of using the positive electrode active material for a lithium secondary cell according to the present invention comprises preparing a positive electrode active material layer-forming liquid comprising the positive electrode active material for a lithium secondary cell obtained by the production method of the positive electrode active material for a lithium secondary cell, and a positive electrode binder, and forming a positive electrode active material layer on a positive electrode current collector by using the positive electrode active material layer-forming liquid. The positive electrode can be fabricated by adding a solvent such as N-methylpyrrolidone to a mixture of the coated positive electrode active material, a positive electrode binder and as required, an electroconductive auxiliary agent and kneading the mixture to thereby prepare a positive electrode active material layer-forming liquid, and applying the positive electrode active material layer-forming liquid onto a positive electrode current collector by a doctor blade method, a die coater method or the like, and drying the resultant.

The method for producing the positive electrode for a lithium secondary cell according to the present invention in the case of using the method of forming a coated positive electrode active material simultaneously with the formation of the positive electrode by using a positive electrode material not containing the coated positive electrode active material comprises fabricating a positive electrode active material layer-forming liquid comprising a positive electrode active material, a positive electrode binder and the phosphonic ester or phosphorous triester, and forming a positive electrode active material layer on a positive electrode current collector by using the positive electrode active material layer-forming liquid.

The positive electrode active material layer-forming liquid can be prepared by adding the phosphonic ester or phosphorous triester preferably so as to become 0.0005 to 0.5 in mass ratio to the positive electrode active material, and more preferably in the range of 0.001 to 0.3, and as required, mixing an electroconductive auxiliary agent and a binder, and adding a solvent such as N-methylpyrrolidone and kneading the mixture. The phosphonic ester or phosphorous triester may be added as a coating-forming liquid containing it. The positive electrode is fabricated by thereafter applying and drying the coating-forming liquid onto a current collector by the same method as in the above.

The method for producing the positive electrode for a lithium secondary cell according to the present invention in the case of using the method of forming a coated positive electrode active material after a positive electrode active material layer is formed by using a positive electrode active material not containing the coated positive electrode active material comprises forming a positive electrode active material layer comprising a positive electrode active material and a positive electrode binder on a positive electrode current collector, and soaking the positive electrode active material layer in a coating-forming liquid comprising the phosphonic ester or phosphorous triester, or applying the coating-forming liquid onto the positive electrode active material layer, to thereby form a coating on at least a part of the positive electrode active material for the sake of forming a coated positive electrode active material.

The coating-forming liquid to be used can be the same one as the above-mentioned coating-forming liquid. The positive electrode is soaked in the coating-forming liquid so that a positive electrode active material layer is soaked therein, or the coating-forming liquid is applied onto the positive electrode active material layer, and the resultant is left at room temperature to 80° C. for 1 hour to 24 hours. Thereafter, the positive electrode is taken out, washed with a nonaqueous solvent, and dried at room temperature to 150° C. under vacuum or atmospheric pressure.

Further, methods of forming a coated positive electrode active material by using a positive electrode active material not containing the coated positive electrode active material include, as described later, a method for producing a lithium secondary cell, in which a predetermined amount of the phosphonic ester or phosphorous triester is incorporated in an electrolytic solution, and left at a predetermined temperature before an activation of a cell.

[Lithium Secondary Battery]

The lithium secondary battery according to the present invention comprises the positive electrode, a negative electrode comprising a negative electrode active material, an electrolytic solution with which these electrodes are penetrated, and an outer package accommodating these.

[Negative Electrode]

The negative electrode suffices if comprising a negative electrode active material, but includes one in which the negative electrode active material is unified with a negative electrode binder and bound so as to cover a negative electrode current collector.

The negative electrode active material includes metals or alloys alloyable with lithium, and oxides and carbon materials capable of intercalating and deintercalating lithium.

The above metals include simple silicon and tin, for example. The oxides include silicon oxides represented by SiOₓ (0<x≤2), niobium pentaoxide (Nb₂O₅), a lithium titanium composite oxide (Li_{4/3}Ti_{5/3}O₄), and titanium dioxide (TiO₂). Among these, the silicon oxides, since lessening the expansion and contraction of the negative electrode active material itself associated with repeated charge and discharge, are preferably used from the viewpoint of charge and discharge cycle characteristics.

The silicon oxide may be crystalline or noncrystalline, may be one containing lithium represented by SiLi_{y}O_{z} (y>0, 2>z>0), and may contain 0.1 to 5% by mass of one or more elements of nitrogen, boron and sulfur in trace amounts. The incorporation of the metal element or the nonmetal element in a trace amount to the silicon oxide enables the electroconductivity of the silicon oxide to be improved.

Use of a silicon oxide together with elemental silicon as the negative electrode active material is preferable because of being able to compensate for the volume change in charge and discharge. The negative electrode active material comprising the elemental silicon and the silicon oxide can be fabricated by mixing the elemental silicon and the silicon oxide and sintering the mixture at a high temperature and under reduced pressure. Further as the negative electrode active material, silicate salts, compounds of a transition metal with silicon, such as nickel silicide and cobalt silicide, and the like can also be used, in addition to the silicon oxide. The negative electrode active material comprising, as a silicon compound, a compound of a transition metal with silicon can be fabricated, for example, by mixing and melting the elemental silicon with the transition metal, or coating the elemental silicon surface with the transition metal by vapor deposition or the like, or otherwise.

The carbon material is preferable because of being good in the cycle characteristics and the safety and excellent in continuous charge characteristics. Examples of the carbon material include graphite materials, amorphous carbon, diamond-like carbon, carbon nanotubes, carbon black, coke, mesocarbon microbeads, hard carbon, and graphite; the graphite material includes artificial graphite and natural graphite; and the carbon black includes acetylene black and furnace black. These can be used singly or in combinations of two or more. Graphite, high in crystallinity, is high in electroconductivity and excellent in adhesiveness with the negative electrode current collector and the voltage flatness. By contrast, amorphous carbon, low in crystallinity, since being relatively low in volume expansion, is large in an effect of lessening the volume expansion of the whole negative electrode and hardly causes deterioration due to heterogeneity including crystal grain boundaries and defects.

It is preferable that the negative electrode active material comprise silicon, a silicon oxide and a carbon material, because of being able to compensate for the volume change associated with charge and discharge; though these can be used simply by being mixed, it is preferable to make a composite (hereinafter, referred to also as a negative electrode composite) comprising these. It is preferable that the negative electrode composite be one having a structure in which the whole or a part of the silicon is dispersed in the silicon oxide wholly or partially having an amorphous structure and the surface is coated with carbon. The silicon oxide having an amorphous structure can suppress the volume expansion of the carbon material and the silicon, and the silicon being dispersed can also suppress the decomposition of an electrolytic solution. The mechanism is not clear, but it is presumed that the silicon oxide having an amorphous structure has some influence on the coating formation on the interface between the carbon material and the electrolytic solution. Further it is conceivable that the amorphous structure has relatively few factors caused by heterogeneity including crystal grain boundaries and defects. It can be confirmed by X-ray diffractometry that the whole or a part of the silicon oxide has an amorphous structure. In cases where the silicon oxide does not have any amorphous structure, in the X-ray diffractometry, a peak characteristic of the silicon oxide is intensely observed. On the other hand, in cases where the whole or a part of the silicon oxide has an amorphous structure, in the X-ray diffractometry, the peak characteristic of the silicon oxide becomes broad.

It can be confirmed by combined use of transmission electron microscope observation and energy-dispersive X-ray spectroscopy that the whole or a part of the silicon is dispersed in the silicon oxide. Specifically, the cross-section of a sample is observed by a transmission electron microscope, and the oxygen concentration in silicon moieties dispersed in the silicon oxide is measured by energy-dispersive X-ray spectroscopy. As a result, it can be confirmed that silicon dispersed in the silicon oxide does not become oxides.

With respect to the content proportions of the silicon, the silicon oxide and the carbon material in the negative electrode composite, the silicon is, in the negative electrode composite, preferably made to be 5% by mass or higher and 90% by mass or lower, and more preferably made to be 20% by mass or higher and 50% by mass or lower. The silicon oxide is, in the negative electrode composite, preferably made to be 5% by mass or higher and 90% by mass or lower, and more preferably made to be 40% by mass or higher and 70% by mass or lower. The carbon material is, in the negative electrode composite, preferably made to be 2% by mass or higher and 50% by mass or lower, and more preferably made to be 2% by mass or higher and 30% by mass or lower.

Such a negative electrode composite can be fabricated, for example, by a method disclosed in JP2004-47404A. That is, by carrying out a CVD treatment in an atmosphere containing an organic gas such as methane gas on the silicon oxide, the negative electrode composite can be obtained in which silicon is nano-clustered in the silicon oxide, and the surface is coated with carbon. Further the surface of the negative electrode composite can also be treated with a silane coupling agent or the like.

The negative electrode active substance may also be a mixture of a particulate elemental silicon, silicon oxide and carbon material. For example, the average particle diameter of the elemental silicon can be configured so as to be smaller than those of the carbon material and the silicon oxide. When thus configured, since the elemental silicon, having a large volume change in the charge and discharge, has relatively a small particle diameter, and the carbon material and silicon oxide, having small volume changes, have relatively large particle diameters, the dendrite formation and producing micronized alloy are more effectively suppressed. In the course of charge and discharge, particles having large particle diameters, particles having small particle diameters and particles having large particle diameters intercalate and deintercalate lithium ions in this order; also from this point, the generation of the residual stress and residual strain is suppressed.

The average particle diameter of the elemental silicon is for example, preferably 20 μm or smaller, and more preferably 15 μm or smaller. The average particle diameter of the silicon oxide is preferably ½ or smaller of that of the carbon material, and the average particle diameter of the elemental silicon is preferably ½ or smaller of that of the silicon oxide. When the average particle diameters are controlled in the above ranges, since the lessening effect of the volume expansion can more effectively be attained, a secondary cell excellent in the balance among the energy density, the cycle life and the efficiency can be obtained. The average particle diameters of the elemental silicon, the silicon oxide and the like are measured by a measuring method such as a laser diffraction scattering method or a dynamic light scattering method.

The amount of the negative electrode active material in the negative electrode active material layer is preferably 55% by mass or larger, and more preferably 65% by mass or larger.

The binder for the negative electrode is not especially limited, but there can be used, for example, polyvinylidene fluoride, vinylidene fluoride-hexafuoropropylene copolymers, vinylidene fluoride-tetrafluoroethylene copolymers, styrene-butadiene copolymer rubber (SBR), polytetrafluoroethylene, polypropylene, polyethylene, polyimide, polyamideimide, and polyacrylic acid or carboxymethylcellulose, including a lithium salt, a sodium salt or a potassium salt neutralized with an alkali. Among these, from the viewpoint of strong bindability, preferable are polyimide, polyamideimide, SBR, and polyacrylic acid or carboxymethylcellulose, including a lithium salt, a sodium salt or a potassium salt neutralized with an alkali. The amount of the binder for the negative electrode to be used is, from the viewpoint of the “sufficient binding capacity” and the “energy enhancement”, which are in a tradeoff relationship, preferably 5 to 25 parts by mass with respect to 100 parts by mass of the negative electrode active material.

The material of the negative electrode current collector includes metal materials such as copper, nickel and stainless steels. Among these, from the viewpoint of workability and cost, copper is especially preferable. It is preferable that the surface of the negative electrode current collector have been previously subjected to a surface-roughening treatment. Further the shape of the current collector may be optional, and includes foil shapes, flat plate shapes and mesh shapes. A current collector of a perforated type such as an expanded metal or a punching metal can also be used.

The negative electrode can be produced by adding a solvent to a mixture of the negative electrode active material, the binder, and as required, various auxiliary agents, and kneading the resultant to make a slurried coating liquid, and coating the current collector with the coating liquid followed by drying.

[Electrolytic Solution]

The electrolytic solution is one in which an electrolyte is dissolved mainly in a nonaqueous organic solvent.

As the solvent, cyclic carbonates, chain type carbonates, chain type esters, lactones, ethers, sulfones, nitriles and phosphate esters, and the like can be used.

The cyclic carbonates include propylene carbonate, ethylene carbonate, fluoroethylene carbonate, butylene carbonate, vinylene carbonate and vinylethylene carbonate.

The chain type carbonates include dimethyl carbonate, diethyl carbonate, dipropyl carbonate, dibutyl carbonate, ethyl methyl carbonate, methyl propyl carbonate, methyl isopropyl carbonate and methyl butyl carbonate.

The chain type esters include methyl formate, methyl acetate, methyl propionate, ethyl propionate, methyl pivalate and ethyl pivalate; the lactones include γ-butyrolactone, δ-valerolactone and α-methyl-γ-butyrolactone; and the ethers include tetrahydrofuran, 2-methyltetrahydrofuran, 1,3-dioxolane, 1,3-dioxane, 1,4-dioxane, 1,2-dimethoxyethane, 1,2-diethoxyethane and 1,2-dibutoxyethane.

The sulfones include sulfolane, 3-methylsulfolane and 2,4-dimethylsulfolane; the nitriles include acetonitrile, propionitrile, succinonitrile, glutaronitrile and adiponitrile; and the phosphates include trimethyl phosphate, triethyl phosphate, tributyl phosphate and trioctyl phosphate.

The above solvents can be used as a combination of one or two or more thereof. The combination of these solvents are preferably those of cyclic carbonates and chain type acyclic carbonates; and further, as a third solvent, there may be added fluorinated ethers, chain type esters or lactones, ethers, nitriles, sulfones, phosphate or the like.

Then, specific examples of the electrolyte include lithium salts such as LiPF₆, LiBF₄ and LiClO₄, and LiN(SO₂F)₂, LiN(SO₂CF₃)₂, LiN(SO₂C₂F₅)₂, CF₃SO₃Li, C₄F₉SO₃Li, LiAsF₆ and LiAlCl₄, LiSbF₆, LiPF₄(CF₃)₂, LiPF₃(C₂F₅)₃, LiPF₃(CF₃)₃, (CF₂)₂(SO₂)₂NLi, (CF₂)₃(SO₂)₂Li. Further lithium bis(oxalate)borate and lithium oxaltodifluoroborate can also be used. These electrolyte salts can be used singly or in combinations of two or more. Among these, preferable are LiPF₆, LiBF₄, LiN(SO₂F)₂, LiN(SO₂CF₃)₂ and LiN(SO₂C₂F₅)₂.

The concentration of the electrolyte in the electrolytic solution is preferably 0.1 to 3M, and more preferably 0.5 to 2M.

The electrolytic solution may further comprise, as other components, for example, vinylene carbonate, fluoroethylene carbonate, maleic anhydride, ethylene sulfite, borate esters, 1,3-propanesultone and 1,5,2,4-dioxadithiane-2,2,4,4-tetraoxide.

[Separator]

As the separator, a monolayer or laminated porous film or nonwoven fabric of a polyolefin such as polypropylene or polyethylene, aramid, polyimide or the like can be used. The separator further includes inorganic materials such as glass fibers, polyolefin films coated with a fluorine compound or inorganic microparticles, laminates of a polyethylene film and a polypropylene film, and a laminate of a polyolefin film with an aramid layer.

The thickness of the separator is, from the viewpoint of the energy density of the cell and the mechanical strength of the separator, preferably 5 to 50 μm, and more preferably 10 to 40 μm.

[Method for Producing the Lithium Secondary Cell]

The method for producing the lithium secondary cell according to the present invention comprises: packing, in an outer package, a positive electrode comprising a positive electrode active material, a negative electrode comprising a negative electrode active material, a separator, and an electrolytic solution containing 0.05% by weight to 10% by weight of at least one selected from phosphonic esters represented by the formula (1):

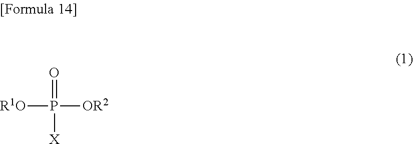

wherein R¹ and R² independently denote a substituted or nonsubstituted alkyl group having 1 to 18 carbon atoms, or a substituted or nonsubstituted aryl group; and X denotes a hydrogen atom or an alkyl group,
and phosphorous triesters represented by the formula (2):

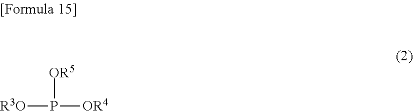

wherein R³ to R⁵ independently denote a substituted or nonsubstituted alkyl group having 1 to 18 carbon atoms, or a substituted or nonsubstituted aryl group;
sealing the outer package to form a sealed body; and thereafter, before an activation treatment, leaving the sealed body at room temperature to 80° C. to form a coating originated from the phosphonic ester represented by the formula (1) or the phosphorous triester represented by the formula (2) on at least a part of the surface of the positive electrode active material.

The electrolytic solution to be used is one comprising the above solvent and the above electrolyte and further containing 0.05% by weight to 10% by weight of the phosphonic ester and/or the phosphorous ester. A positive electrode active material layer having no coated positive electrode active material is formed on a positive electrode current collector; a negative electrode active material layer is formed on a negative electrode current collector; these are accommodated in an outer package; an electrolytic solution is filled; the outer package is sealed to form a sealed body; and the sealed body is, before an activation treatment, left at room temperature to 80° C. Thereby, there is formed a coated positive electrode active material having a coating on at least a part of the surface of the positive electrode active material. The temperature treatment carried out before the activation treatment suffices if being at room temperature to 80° C., but is more preferably at 40 to 60° C. The temperature treatment time can be selected in relation to the temperature, and can be made to be, for example, around 10 to 40 hours from the viewpoint of production efficiency, and is more preferably 10 to 30 hours.

[Shape of the Lithium Secondary Cell]

For a coin cell, a cylindrical cell, a laminate-type cell or the like having a monolayer or laminated separator as the lithium secondary cell, the above-mentioned constitution can be used.

For example, in the case of a laminate-type lithium ion cell, the cell has a shape in which the positive electrode, the separator and the negative electrode are alternately laminated; these electrodes are connected to the tabs of metal terminals respectively; the resultant is put in the outer package of a laminate film or the like; the electrolytic solution is injected; and the outer package is sealed.

It is preferable that the outer package be one having a strength of being capable of stably holding the positive electrode and the negative electrode laminated through the separator and the electrolytic solution with which these electrodes are penetrated, and having the electrochemical stability to these substances and the airtightness and watertightness. For the outer package, there can be used, specifically, for example, stainless steel, nickel-plated iron, aluminum, titanium, or an alloy thereof or a plated one thereof, a metal laminate resin, or the like. The metal laminate film is one made by laminating a metal thin film on a heat-fusible resin film, and preferably the one stable to the electrolytic solution and has the airtightness and watertightness. As the heat-fusible resin, there can be used polypropylene and polyethylene, acid-modified polypropylene or polyethylene, polyphenylene sulfide, polyester such as polyethylene terephthalate, polyamide, ethylene-vinyl acetate copolymers, or ionomer resins made by intermolecularly bonding an ethylene-methacrylic acid copolymer or an ethylene-acrylic acid copolymer with a metal ion, or the like. The thickness of the heat-fusible resin film is preferably 10 to 200 μm, and more preferably 30 to 100 μm.

As the metal laminate film, polypropylene and polyethylene coated with aluminum, silica or alumina, or the like can be used. From the viewpoint of suppressing the volume expansion, an aluminum laminate film is preferable. Further the laminate film includes ones made by laminating a protection layer composed of a film of a polyester such as a polyethylene terephthalate, a polyamide or the like on the other side of surface of the above laminate film having metal thin film provided thereon.

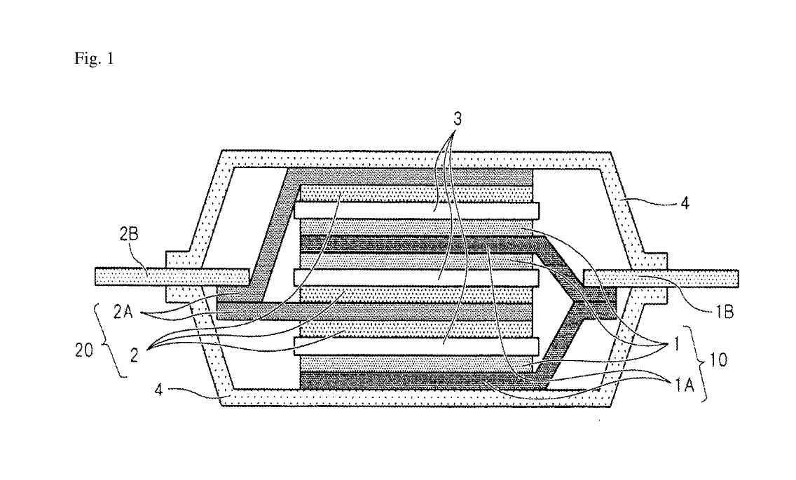

One example of a lithium ion secondary cell of the present invention is illustrated in a schematic constitution view of FIG. 1. In the lithium secondary cell shown in FIG. 1, a positive electrode 10 in which a positive electrode active material layer 1 is provided on both surfaces each or one surface of positive electrode current collectors 1A each and a negative electrode 20 in which a negative electrode active material layer 2 is provided on both surfaces each or one surface of negative electrode current collectors 2A each are laminated through porous separators 3, and filled together with an electrolytic solution (not shown in FIGURE) in outer packages 4 composed of an aluminum-deposited laminate film. A positive electrode tab 1B formed of an aluminum plate is connected to a portion of the positive electrode current collectors 1A where no positive electrode active material layer 1 is provided; and a negative electrode tab 2B formed of a nickel plate is connected to a portion of the negative electrode current collectors 2A where no negative electrode active material layer 2 is provided, and the tips are led out outside the outer packages 4.

### EXAMPLES

Hereinafter, there will be described in detail positive electrode active materials for a lithium secondary cell, positive electrodes for a lithium secondary cell, methods for producing these, and lithium secondary cells using these of the present invention, but the present invention is not any more limited to these Examples.

### Example 1

### Production of a Positive Electrode Active Material for a Lithium Secondary Cell

0.09 g of diethyl phosphonate was dissolved in 90 g of diethyl carbonate (DEC) to prepare a coating-forming liquid. A lithium transition metal composite oxide (Li_{1.26}Fe_{0.11}Ni_{0.11}Mn_{0.52}O₂) of 50 g was added to the obtained coating-forming liquid, and left at 45° C. for 18 hours. Lithium oxide was filtered out from the solution, and washed with DEC; and the washed lithium oxide was dried in a nitrogen gas flow at 120° C. overnight to obtain a lithium transition metal composite oxide which was a coated positive electrode active material coated with diethyl phosphonate.

### Example 2

### Production of a Positive Electrode for a Lithium Secondary Cell

There was prepared a slurry containing 92% by mass of a lithium transition metal composite oxide (Li_{1.26}Fe_{0.11}Ni_{0.11}Mn_{0.52}O₂), 4% by mass of Ketjen black and 4% by mass of a polyvinylidene fluoride. Then, the prepared slurry was applied and dried onto a positive electrode current collector composed of an aluminum foil (thickness: 20 μm) to fabricate a positive electrode active material layer of 175 μm in thickness. A positive electrode active material layer was formed on the surface of the positive electrode current collector provided with no positive electrode active material layer by the same procedure to fabricate a positive electrode having the positive electrode active material layers on two sides of the positive electrode current collector.

The fabricated positive electrode was put in an aluminum laminate film; a DEC solution of diethyl phosphonate (concentration: 1% by mass) was added thereto, and subjected to a vacuum penetrating treatment; and the film was sealed, and thereafter the resultant was left in a thermostatic chamber at 45° C. for 24 hours. The electrode was taken out, washed with DEC, and dried in a nitrogen gas flow at 120° C. for 1 hour to obtain a positive electrode having a coated positive electrode active material coated with diethyl phosphonate.

### Example 3

### Production of a Positive Electrode for a Lithium Secondary Cell

There was prepared a slurry containing 91.8% by mass of a lithium transition metal composite oxide (Li_{1.26}Fe_{0.11}Ni_{0.11}Mn_{0.52}O₂), 4% by mass of Ketjen black, 4% by mass of a polyvinylidene fluoride, and 0.2% by mass of diethyl phosphonate to obtain a positive electrode active material layer-forming liquid. The prepared slurry was applied and dried onto a positive electrode current collector composed of an aluminum foil (thickness: 20 μm) to fabricate a positive electrode active material layer of 175 μm in thickness. A positive electrode active material layer was formed on the surface of the positive electrode current collector provided with no positive electrode active material layer by the same procedure to fabricate a positive electrode having the positive electrode active material layer on two sides of the positive electrode current collector.

### Example 4

### Production of a Positive Electrode for a Lithium Secondary Cell

A positive electrode having a coated positive electrode active material coated with triethyl phosphite was obtained by fabricating positive electrode active material layers as in Example 2, except for using a DEC solution of triethyl phosphite (concentration: 1.2% by mass) in place of the DEC solution of diethyl phosphonate (concentration: 1% by mass).

### Example 5

### Production of a Positive Electrode for a Lithium Secondary Cell

A positive electrode having a coated positive electrode active material coated with di(2-ethylhexyl) phosphonate was obtained by fabricating positive electrode active material layers as in Example 2, except for using a DEC solution of di(2-ethylhexyl) phosphonate (concentration: 2.2% by mass) in place of the DEC solution of diethyl phosphonate (concentration: 1% by mass).

### Example 6

### Production of a Positive Electrode for a Lithium Secondary Cell

A positive electrode having a coated positive electrode active material coated with diphenylmonodecyl phosphonate was obtained by fabricating positive electrode active material layers as in Example 2, except for using a DEC solution of diphenylmonodecyl phosphonate (concentration: 2.7% by mass) in place of the DEC solution of diethyl phosphonate (concentration: 1% by mass).

### Example 7

### Production of a Positive Electrode for a Lithium Secondary Cell

A positive electrode having a coated positive electrode active material coated with tridecyl phosphite was obtained by fabricating positive electrode active material layers as in Example 2, except for using a DEC solution of tridecyl phosphite (concentration: 3.4% by mass) in place of the DEC solution of diethyl phosphonate (concentration: 1% by mass).

### Example 8

### Production of a Positive Electrode for a Lithium Secondary Cell

A positive electrode having a coated positive electrode active material coated with diethyl ethylphosphonate was obtained by fabricating positive electrode active material layers as in Example 2, except for using a DEC solution of diethyl ethylphosphonate (concentration: 1% by mass) in place of the DEC solution of diethyl phosphonate (concentration: 1% by mass).

### Example 9

### Production of a Positive Electrode for a Lithium Secondary Cell

A positive electrode was obtained by fabricating positive electrode active material layers as in Example 2, except for using a positive electrode active material Li_{1.23}Fe_{0.15}Ni_{0.15}Mn_{0.46}O₂ in place of the positive electrode active material Li_{1.26}Fe_{0.11}Ni_{0.11}Mn_{0.52}O₂.

### Example 10

### Production of a Positive Electrode for a Lithium Secondary Cell

A positive electrode was obtained by fabricating positive electrode active material layers as in Example 2, except for using a positive electrode active material Li_{1.2}Ni_{0.18}Mn_{0.54}Co_{0.08}O₂ in place of the positive electrode active material Li_{1.26}Fe_{0.11}Ni_{0.11}Mn_{0.52}O₂.

### Example 11

### Production of a Positive Electrode for a Lithium Secondary Cell

A positive electrode was obtained by fabricating positive electrode active material layers as in Example 2, except for using a positive electrode active material LiNi_{0.8}Co_{0.15}Al_{0.05}O₂ in place of the positive electrode active substance Li_{1.26}Fe_{0.11}Ni_{0.11}Mn_{0.52}O₂.

### Example 12

### Production of a Positive Electrode for a Lithium Secondary Cell

A positive electrode was obtained by fabricating positive electrode active material layers as in Example 2, except for using a positive electrode active material LiNi_{0.8}Co_{0.1}Mn_{0.1}O₂ in place of the positive electrode active substance Li_{1.26}Fe_{0.11}Ni_{0.11}Mn_{0.52}O₂.

### Example 13

### Production of a Lithium Secondary Cell

There was prepared a slurry containing 92% by weight of the lithium oxide coated with diethyl phosphonate obtained in Example 1, 4% by weight of Ketjen black and 4% by weight of a polyvinylidene fluoride. Then, the prepared slurry was applied and dried onto a positive electrode current collector composed of an aluminum foil (thickness: 20 μm) to thereby fabricate a positive electrode active material layer of 175 μm in thickness. A positive electrode active material layer was formed on the surface of the positive electrode current collector provided with no positive electrode active material layer by the same procedure to fabricate a positive electrode having the positive electrode active material layer on two sides of the positive electrode current collector.

There was prepared a slurry containing 85% by weight of SiO of 15 μm in average particle diameter, and 15% by weight of a polyamic acid. Then, a negative electrode current collector composed of a copper foil (thickness: 10 μm) was coated with the slurry followed by drying to fabricate a negative electrode active material layer of 46 μm in thickness. Then, the fabricated negative electrode active material layer was annealed in a nitrogen atmosphere at 350° C. for 3 hours to cure the binder to obtain a negative electrode.

An electrolyte of 1.0M LiPF₆ was dissolved in a mixed solvent of ethylene carbonate (EC) and diethyl carbonate (DEC) in 30:70 in volume ratio to prepare an electrolytic solution.

A positive electrode tab and a negative electrode tab were welded to the positive electrode current collectors and the negative electrode current collectors, respectively, and thereafter, a separator of a porous film was interposed each between the fabricated positive electrodes and the negative electrodes to form a laminate. The laminate was covered with two sheets of aluminum laminate film outer packages, and three superposed sides of the outer packages were thermally fused and sealed; and thereafter, the laminate was penetrated with the fabricated electrolytic solution at a suitable vacuum. Thereafter, under reduced pressure, one superposed side left thermally unfused of the outer packages was then thermally fused and sealed to fabricate a lithium cell before an activation treatment.

The fabricated lithium cell before an activation treatment was charged up to 4.5 V at a current of 20 mA (20 mA/g) per 1 g of the positive electrode active material. Thereafter, the cell was discharged down to 1.5 V at a current of 20 mA (20 mA/g) per 1 g of the positive electrode active material. After the discharge to 1.5 V, the cell was similarly charged up to 4.5 V and then discharged down to 1.5 V at 20 mA/g, thus carrying out an activation treatment in which the charge and discharge cycle was repeated twice. Thereafter, gases in the battery interior was extracted by pressure reduction by breaking a sealed portion of the outer packages and the broken portion was re-sealed to thereby fabricate a lithium secondary cell.

[Evaluation of the Lithium Secondary Cell]

[The Capacity Retention Rate]

The obtained lithium secondary cell was charged, in a thermostatic chamber at 45° C., at a constant current of 40 mA/g up to 4.5 V, and continuously charged at a constant voltage of 4.5 V until the current became 5 mA/g. Thereafter, the cell was discharged at a current of 5 mA/g down to 1.5 V to carry out conditioning. The lithium ion cell after the conditioning was charged in a thermostatic chamber at 45° C. at a constant current of 40 mA/g up to 4.5 V, and further continuously charged at a constant voltage of 4.5 V until the current became 5 mA/g, and thereafter discharged at a current of 40 mA/g down to 1.5 V. The charge and discharge under this condition was repeated 30 times totally. From the ratio of a discharge capacity acquired at the 30th cycle to an initial discharge capacity acquired at the first cycle, the capacity retention rate after 30 cycles was determined. Results are shown in Table 2.

### [Amount of Gases Generated]

The amount of gases generated in the 30 cycles was measured by the Archimedes method, and was determined as a relative value thereof where the amounts of gases generated in Comparative Examples having no coating and using the same positive electrode active materials were taken to be 100. Results are shown in Table 2.

### Example 14

### Production of a Lithium Secondary Cell

A lithium secondary cell was fabricated and evaluated as in Example 13, except for using the positive electrode obtained in Example 2 in place of the positive electrode fabricated in Example 13. Results are shown in Table 2.

### Example 15

### Production of a Lithium Secondary Cell

A lithium secondary cell was fabricated and evaluated as in Example 13, except for using the positive electrode obtained in Example 3 in place of the positive electrode fabricated in Example 13. Results are shown in Table 2.

### Example 16

### Production of a Lithium Secondary Cell

A lithium secondary cell was fabricated and evaluated as in Example 13, except for using the positive electrode obtained in Example 4 in place of the positive electrode fabricated in Example 13. Results are shown in Table 2.

### Example 17

### Production of a Lithium Secondary Cell

A lithium secondary cell was fabricated and evaluated as in Example 13, except for using the positive electrode obtained in Example 5 in place of the positive electrode fabricated in Example 13. Results are shown in Table 2.

### Example 18

### Production of a Lithium Secondary Cell

A lithium secondary cell was fabricated and evaluated as in Example 13, except for using the positive electrode obtained in Example 6 in place of the positive electrode fabricated in Example 13. Results are shown in Table 2.

### Example 19

### Production of a Lithium Secondary Cell

A lithium secondary cell was fabricated and evaluated as in Example 13, except for using the positive electrode obtained in Example 7 in place of the positive electrode fabricated in Example 13. Results are shown in Table 2.

### Example 20

### Production of a Lithium Secondary Cell

A lithium secondary cell was fabricated and evaluated as in Example 13, except for using the positive electrode obtained in Example 8 in place of the positive electrode fabricated in Example 13. Results are shown in Table 2.

### Example 21

### Production of a Lithium Secondary Cell

A lithium secondary cell was fabricated and evaluated as in Example 13, except for using the positive electrode obtained in Example 9 in place of the positive electrode fabricated in Example 13. Results are shown in Table 2.

### Example 22

### Production of a Lithium Secondary Cell

A lithium secondary cell was fabricated and evaluated as in Example 13, except for using the positive electrode obtained in Example 10 in place of the positive electrode fabricated in Example 13. Results are shown in Table 2.

### Example 23

### Production of a Lithium Secondary Cell

A lithium secondary cell was fabricated and evaluated as in Example 13, except for using the positive electrode obtained in Example 11 in place of the positive electrode fabricated in Example 13. Results are shown in Table 2.

### Example 24

A lithium secondary cell was fabricated and evaluated as in Example 13, except for using the positive electrode obtained in Example 12 in place of the positive electrode fabricated in Example 13. Results are shown in Table 2.

### Example 25

A sealed body was fabricated by sealing an outer package as in Example 13, except for using a lithium transition metal oxide (Li_{0.26}Fe_{0.11}Ni_{0.11}Mn_{0.52}O₂) in which no diethyl phosphonate coating was formed in place of the lithium transition metal oxide, in which a diethyl phosphonate coating was formed, obtained in Example 1, and using an electrolytic solution in which 1% by mass of diethyl phosphonate was added. The fabricated sealed body was left in a thermostatic chamber at 45° C. for 24 hours to fabricate a lithium secondary cell, which was then evaluated as in Example 13. Results are shown in Table 2.

### Example 26

A lithium secondary cell was fabricated as in Example 25, except for using an electrolytic solution in which 1% by mass of triethyl phosphite in place of the electrolytic solution in which 1% of diethyl phosphonate was added, and was evaluated as in Example 13. Results are shown in Table 2.

### Example 27

A lithium secondary cell was fabricated as in Example 25, except for using an electrolytic solution in which 1% by mass of diethyl ethylphosphonate in place of the electrolytic solution in which 1% of diethyl phosphonate was added, and was evaluated as in Example 13. Results are shown in Table 2.

### Comparative Example 1

A lithium secondary cell was fabricated and evaluated as in Example 13, except for using a lithium transition metal composite oxide prepared by using no diethyl phosphonate. Results are shown in Table 2.

### Comparative Example 2

A lithium secondary cell was fabricated and evaluated as in Example 13, except for using a positive electrode fabricated as in Example 8 except for using no diethyl ethyl phosphonate for the positive electrode. Results are shown in Table 2.

### Comparative Example 3

A lithium secondary cell was fabricated and evaluated as in Example 13, except for using a positive electrode fabricated as in Example 9 except for using no diethyl phosphonate for the positive electrode. Results are shown in Table 2.

### Comparative Example 4

A lithium secondary cell was fabricated and evaluated as in Example 13, except for using a positive electrode fabricated as in Example 10 except for using no diethyl phosphonate for the positive electrode. Results are shown in Table 2.

### Comparative Example 5

A lithium secondary cell was fabricated and evaluated as in Example 13, except for using a positive electrode fabricated as in Example 11 except for using no diethyl phosphonate for the positive electrode. Results are shown in Table 2.

TABLE 2

| | | | Amount | Capacity |
|---|---|---|---|---|
| | Phosphonate Ester or | Positive Electrode | of Gases | Retention |
| | Phosphite Triester | Material | Generated¹⁾ | Rate |
| Example 13 | diethyl phosphonate | Li_{1.26}Fe_{0.11}Ni_{0.11}Mn_{0.52}O₂ | 55 | 70% |
| Example 14 | diethyl phosphonate | Li_{1.26}Fe_{0.11}Ni_{0.11}Mn_{0.52}O₂ | 30 | 73% |
| Example 15 | diethyl phosphonate | Li_{1.26}Fe_{0.11}Ni_{0.11}Mn_{0.52}O₂ | 32 | 72% |
| Example 16 | triethyl phosphite | Li_{1.26}Fe_{0.11}Ni_{0.11}Mn_{0.52}O₂ | 28 | 70% |
| Example 17 | di(2-ethylhexyl) | Li_{1.26}Fe_{0.11}Ni_{0.11}Mn_{0.52}O₂ | 32 | 69% |
| | phosphonate | | | |
| Example 18 | diphenyl monodecyl | Li_{1.26}Fe_{0.11}Ni_{0.11}Mn_{0.52}O₂ | 33 | 68% |
| | phosphonate | | | |
| Example 19 | tridecyl phosphite | Li_{1.26}Fe_{0.11}Ni_{0.11}Mn_{0.52}O₂ | 35 | 68% |
| Example 20 | diethyl ethylphosphonate | Li_{1.26}Fe_{0.11}Ni_{0.11}Mn_{0.52}O₂ | 31 | 73% |
| Example 25 | diethyl phosphonate | Li_{1.26}Fe_{0.11}Ni_{0.11}Mn_{0.52}O₂ | 29 | 74% |
| Example 26 | triethyl phosphite | Li_{1.26}Fe_{0.11}Ni_{0.11}Mn_{0.52}O₂ | 30 | 73% |
| Example 27 | diethyl ethylphosphonate | Li_{1.26}Fe_{0.11}Ni_{0.11}Mn_{0.52}O₂ | 32 | 73% |
| Comparative | none | Li_{1.26}Fe_{0.11}Ni_{0.11}Mn_{0.52}O₂ | 100 | 58% |
| Example 1 | | | | |
| Example 21 | diethyl phosphonate | Li_{1.23}Fo_{0.15}Ni_{0.15}Mn_{0.64}O₂ | 31 | 74.% |
| Comparative | none | Li_{1.23}Fe_{0.15}Ni_{0.15}Mn_{0.54}O₂ | 100 | 60% |
| Example 2 | | | | |
| Example 22 | diethyl phosphonate | Li_{1.2}Ni_{0.18}Mn_{0.54}Co_{0.08}O₂ | 59 | 78% |
| Comparative | none | Li_{1.2}Ni_{0.18}Mn_{0.54}Co_{0.08}O₂ | 100 | 67% |
| Example 3 | | | | |
| Example 23 | diethyl phosphonate | LiNi_{0.8}Co_{0.15}Al_{0.05}O₂ | 60 | 80% |
| Comparative | none | LiNi_{0.8}Co_{0.15}Al_{0.05}O₂ | 100 | 68% |
| Example 4 | | | | |
| Example 24 | diethyl phosphonate | LiNi_{0.8}Co_{0.1}Mn_{0.1}O₂ | 64 | 80% |
| Comparative | none | LiNi_{0.8}Co_{0.1}Mn_{0.1}O₂ | 100 | 70% |
| Example 5 | | | | |

¹⁾values where the amount of gases generated in a lithium secondary cell (Comparative Examples 1 to 5), using a positive electrode active substance coated with no phosphonic ester nor phosphorous triester, was taken to be 100

From the results, with respect to the amount of gases generated, it was confirmed that Examples 13 to 20 and 25 to 27 were reduced in the amount to about 28 to 55% of Comparative Example 1. It was confirmed that Example 21 was reduced in the amount to 31% of Comparative Example 2; Example 22, to 59% of Comparative Example 3; Example 23, to 60% of Comparative Example 4; and Example 24, to 64% of Comparative Example 5.

On the other hand, with respect to the capacity retention rate, it was confirmed that Examples 13 to 27 were improved in the rate by 10 or more points as compared with Comparative Examples 1 to 5.

From comparison of Examples 13 to 27 with Comparative Examples 1 to 5, it was confirmed that by coating a positive electrode active material with at least one compound selected from the group consisting of phosphonic esters and phosphorous triesters, the amount of gases generated in the charge and discharge cycle of a lithium secondary cell can be suppressed and a high capacity retention rate can be attained.

As described above, the lithium secondary cell using a positive electrode active material coated with at least one selected from the group consisting of phosphonic esters and phosphorous triesters according to the present invention exhibits such excellent characteristics that the gas generation associated with the charge and discharge cycle can be suppressed and a high capacity retention rate can be attained.

### INDUSTRIAL APPLICABILITY

The lithium secondary cell using positive electrode active material for lithium secondary cell and positive electrode for lithium secondary cell of the present invention can be utilized in every industrial field necessitating power sources, and the industrial fields related to transport, storage and supply of electric energy. Specifically, the cell can be utilized as power sources for mobile devices such as cell phones, laptop computers, tablet computers and portable game machines. The cell can further be utilized as power sources for media for movement and transportation such as electric cars, hybrid cars, electric motorcycles, power-assisted bicycles, and the like. The cell can still further be utilized for backup power sources for household power storage systems, UPSs and the like, power storage facilities to store power generated by solar power generation, wind power generation, and the like.

### REFERENCE SIGNS LIST

1 POSITIVE ELECTRODE ACTIVE MATERIAL LAYER
1A POSITIVE ELECTRODE CURRENT COLLECTOR
1B POSITIVE ELECTRODE TAB
10 POSITIVE ELECTRODE (CATHODE)
2 NEGATIVE ELECTRODE ACTIVE MATERIAL LAYER
2A NEGATIVE ELECTRODE CURRENT COLLECTOR
2B NEGATIVE ELECTRODE TAB
20 NEGATIVE ELECTRODE (ANODE)
3 POROUS SEPARATOR
4 LAMINATE FILM OUTER PACKAGE

### SUPPLEMENTARY NOTES

A part or the whole of the above exemplary embodiment can be described also as the following supplementary notes, but is not limited to the following.

### Supplementary Note 1

A positive electrode active material for a lithium secondary cell, comprising a coated positive electrode active material having a coating comprising at least one selected from phosphonic esters represented by the formula (1):

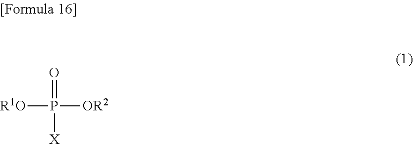

wherein R¹ and R² independently denote a substituted or nonsubstituted alkyl group having 1 to 18 carbon atoms, or a substituted or nonsubstituted aryl group; and X denotes an alkyl group,
and phosphorous triesters represented by the formula (2):

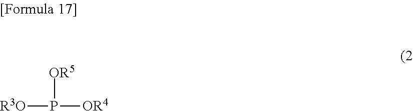

wherein R³ to R⁵ independently denote a substituted or nonsubstituted alkyl group having 1 to 18 carbon atoms, or a substituted or nonsubstituted aryl group.

### Supplementary Note 2

The positive electrode active material for a lithium secondary cell according to Supplementary Note 1, wherein the positive electrode active material comprises a lithium transition metal composite oxide.

### Supplementary Note 3

The positive electrode active material for a lithium secondary cell according to Supplementary Note 1 or 2, wherein the positive electrode active material comprises at least one selected from LiMnO₂, LiₓMn₂O₄ (0<x<2), LiCoO₂, LiNiO₂, LiCo₁₋ₓNiₓO₂ (0.01<x<1), LiNiₓCo_{y}Mn_{z}O₂ (x+y+z=1), LiNi_{0.5}Mn_{1.5}O₄, Li_{α}Ni_{β}Co_{γ}Al_{δ}O₂ (1≤cα≤1.2, β+γ+δ=1, β≥0.7, γ≤0.2), LiFePO₄, lithium transition metal composite oxides which comprise lithium in excessive amount to stoichiometric composition, and those obtained by replacing a part of these transition metals by another metal.

### Supplementary Note 4

The positive electrode active material for a lithium secondary cell according to Supplementary Note 3, wherein the lithium transition metal composite oxide which comprises lithium in excessive amount to stoichiometric composition comprises at least one selected from Li₁₊ₐNiₓMn_{y}O₂ (0<a≤0.5, 0<x<1, 0<y<1) and Li₁₊ₐNiₓMn_{y}M_{z}O₂ (0<a≤0.5, 0<x<1, 0<y<1, 0<z<1, and M is Co or Fe).

### Supplementary Note 5

A positive electrode for a lithium secondary cell having, on a positive electrode current collector, a positive electrode active material layer comprising a positive electrode active material for a lithium secondary cell according to any one of Supplementary Notes 1 to 4.

### Supplementary Note 6

A lithium secondary cell, comprising a positive electrode for a lithium secondary cell according to Supplementary Note 5, a negative electrode comprising a negative electrode active material, an electrolytic solution penetrating these electrodes, and an outer package accommodating these.

### Supplementary Note 7

The lithium secondary cell according to Supplementary Note 6, wherein the negative electrode comprises one or more selected from carbon materials, silicon and silicon oxides.

### Supplementary Note 8

The lithium secondary cell according to Supplementary Note 6 or 7, wherein the electrolytic solution comprises one or more selected from acyclic carbonate-based solvents and cyclic carbonate-based solvents.

### Supplementary Note 9

A method for producing a positive electrode active material for a lithium secondary cell, comprising soaking a positive electrode active material in a coating-forming liquid comprising at least one selected from phosphonic esters represented by the formula (1):

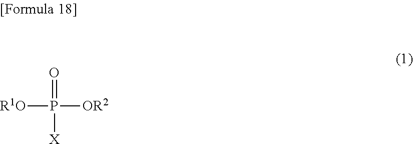

wherein R¹ and R² independently denote a substituted or nonsubstituted alkyl group having 1 to 18 carbon atoms, or a substituted or nonsubstituted aryl group; and X denotes an alkyl group,
and phosphorous triesters represented by the formula (2):

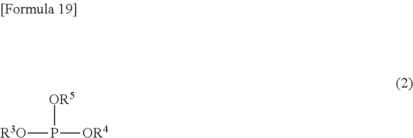

wherein R³ to R⁵ independently denote a substituted or nonsubstituted alkyl group having 1 to 18 carbon atoms, or a substituted or nonsubstituted aryl group,
to form a coating on at least a part of the positive electrode active material for the sake of forming a coated positive electrode active material.

### Supplementary Note 10

A method for producing a positive electrode for a lithium secondary cell, comprising: preparing a positive electrode active material layer-forming liquid comprising the positive electrode active material for a lithium secondary cell obtained by a method for producing a positive electrode active material for a lithium secondary cell according to Supplementary Note 9, and a positive electrode binder; and forming a positive electrode active material layer on a positive electrode current collector by using the positive electrode active material layer-forming liquid.

### Supplementary Note 11

A method for producing a positive electrode for a lithium secondary cell, comprising: preparing a positive electrode active material layer-forming liquid comprising a positive electrode active material, a positive electrode binder, and at least one selected from phosphonic esters represented by the formula (1):

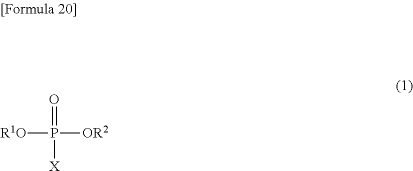

wherein R¹ and R² independently denote a substituted or nonsubstituted alkyl group having 1 to 18 carbon atoms, or a substituted or nonsubstituted aryl group; and X denotes an alkyl group,
and phosphorous triesters represented by the formula (2):

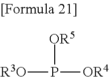

wherein R³ to R⁵ independently denote a substituted or nonsubstituted alkyl group having 1 to 18 carbon atoms, or a substituted or nonsubstituted aryl group;
and forming a positive electrode active material layer on a positive electrode current collector by using the positive electrode active material layer-forming liquid.

### Supplementary Note 12

A method for producing a positive electrode for a lithium secondary cell, comprising: forming a positive electrode active material layer comprising a positive electrode active material and a positive electrode binder on a positive electrode current collector; and soaking the positive electrode active material layer in a coating-forming liquid comprising at least one selected from phosphonic esters represented by the formula (1):

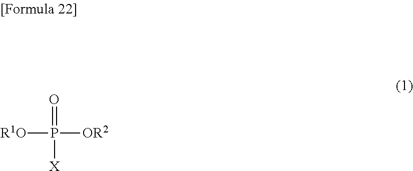

wherein R¹ and R² independently denote a substituted or nonsubstituted alkyl group having 1 to 18 carbon atoms, or a substituted or nonsubstituted aryl group; and X denotes an alkyl group,
and phosphorous triesters represented by the formula (2):

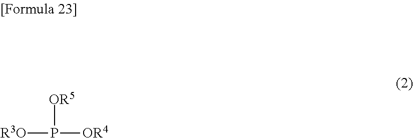

wherein R³ to R⁵ independently denote a substituted or nonsubstituted alkyl group having 1 to 18 carbon atoms, or a substituted or nonsubstituted aryl group;
or applying the coating-forming liquid onto the positive electrode active material layer, to form a coating on at least a part of the positive electrode active material for the sake of forming a coated positive electrode active material.

### Supplementary Note 13

A method for producing a lithium secondary cell, comprising: packing, in an outer package, a positive electrode comprising a positive electrode active material, a negative electrode comprising a negative electrode active material, a separator, and an electrolytic solution containing 0.05% by weight to 10% by weight of at least one selected from phosphonic esters represented by the formula (1):

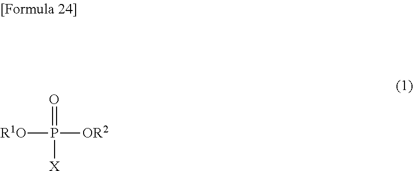

wherein R¹ and R² independently denote a substituted or nonsubstituted alkyl group having 1 to 18 carbon atoms, or a substituted or nonsubstituted aryl group; and X denotes an alkyl group,
and phosphorous triesters represented by the formula (2):

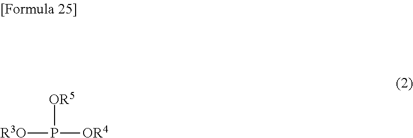

wherein R³ to R⁵ independently denote a substituted or nonsubstituted alkyl group having 1 to 18 carbon atoms, or a substituted or nonsubstituted aryl group;
sealing the outer package to form a sealed body; and thereafter, before an activation treatment, leaving the sealed body at room temperature to 80° C. to form a coating originated from the phosphonic ester represented by the formula (1) or the phosphorous triester represented by the formula (2) on at least a part of the surface of the positive electrode active material.

### Supplementary Note 14

A positive electrode active material for a lithium secondary cell, comprising a coated positive electrode active material having a coating comprising at least one selected from phosphonic esters represented by the formula (1):

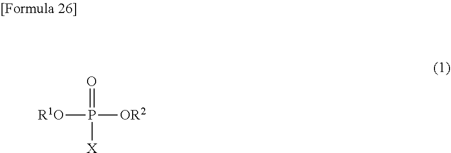

wherein R¹ and R² independently denote a substituted or nonsubstituted alkyl group having 1 to 18 carbon atoms, or a substituted or nonsubstituted aryl group; and X denotes a hydrogen atom or an alkyl group,
and phosphorous triesters represented by the formula (2):

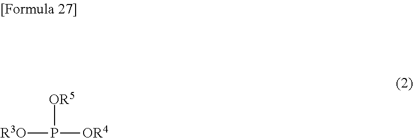

wherein R³ to R⁵ independently denote a substituted or nonsubstituted alkyl group having 1 to 18 carbon atoms, or a substituted or nonsubstituted aryl group.

### Supplementary Note 15

The positive electrode active material for a lithium secondary cell according to Supplementary Note 14, wherein the positive electrode active material comprises a lithium transition metal composite oxide.

### Supplementary Note 16

The positive electrode active material for a lithium secondary cell according to Supplementary Note 14 or 15, wherein the positive electrode active material comprises at least one selected from LiMnO₂, LiₓMn₂O₄ (0<x<2), LiCoO₂, LiNiO₂, LiCo₁₋ₓNiₓO₂ (0.01<x<1), LiNiₓCo_{y}Mn_{z}O₂ (x+y+z=1), LiNi_{0.5}Mn_{1.5}O₄, Li_{α}Ni_{β}Co_{γ}Al_{δ}O₂ (1≤β≤1.2, β+γ+δ=1, β≥0.7, γ≤0.2), LiFePO₄, lithium transition metal composite oxides which comprise lithium in excessive amount to stoichiometric compositions, and those obtained by replacing a part of these transition metals by another metal.

### Supplementary Note 17

The positive electrode active material for a lithium secondary cell according to Supplementary Note 16, wherein the lithium transition metal composite oxide which comprises lithium in excessive amount to the stoichiometric composition comprises at least one selected from Li₁₊ₐNiₓMn_{y}O₂ (0<a≤0.5, 0<x<1, 0<y<1) and Li₁₊ₐNiₓMn_{y}M_{z}O₂ (0<a≤0.5, 0<x<1, 0<y<1, 0<z<1, and M is Co or Fe).

### Supplementary Note 18

A positive electrode for a lithium secondary cell having, on a positive electrode current collector, a positive electrode active material layer comprising a positive electrode active material for a lithium secondary cell according to any one of Supplementary Notes 14 to 17.

### Supplementary Note 19

A lithium secondary cell, comprising: a positive electrode for a lithium secondary cell according to Supplementary Note 18, a negative electrode comprising a negative electrode active material, an electrolytic solution penetrating these electrodes, and an outer package accommodating these.

### Supplementary Note 20

The lithium secondary cell according to Supplementary Note 19, wherein the negative electrode comprises one or more selected from carbon materials, silicon and silicon oxides.

### Supplementary Note 21

The lithium secondary cell according to Supplementary Note 19 or 20, wherein the electrolytic solution comprises one or more selected from acyclic carbonate-based solvents and cyclic carbonate-based solvents.

### Supplementary Note 22

A method for producing a positive electrode active material for a lithium secondary cell, comprising soaking a positive electrode active material in a coating-forming liquid comprising at least one selected from phosphonic esters represented by the formula (1):

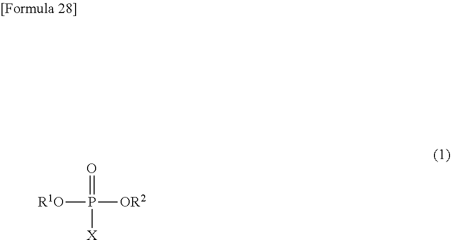

wherein R¹ and R² independently denote a substituted or nonsubstituted alkyl group having 1 to 18 carbon atoms, or a substituted or nonsubstituted aryl group; and X denotes a hydrogen atom or an alkyl group,
and phosphorous triesters represented by the formula (2):

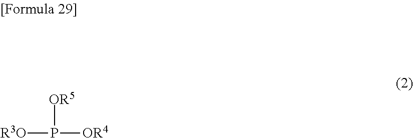

wherein R³ to R⁵ independently denote a substituted or nonsubstituted alkyl group having 1 to 18 carbon atoms, or a substituted or nonsubstituted aryl group,
to form a coating on at least a part of the positive electrode active material for the sake of forming a coated positive electrode active material.

### Supplementary Note 23

A method for producing a positive electrode for a lithium secondary cell, comprising: preparing a positive electrode active material layer-forming liquid comprising the positive electrode active material for a lithium secondary cell obtained by a method for producing a positive electrode active material for a lithium secondary cell according to Supplementary Note 22, and a positive electrode binder; and forming a positive electrode active material layer on a positive electrode current collector by using the positive electrode active material layer-forming liquid.

### Supplementary Note 24

A method for producing a positive electrode for a lithium secondary cell, comprising: preparing a positive electrode active material layer-forming liquid comprising a positive electrode active material, a positive electrode binder, and at least one selected from phosphonic esters represented by the formula (1):

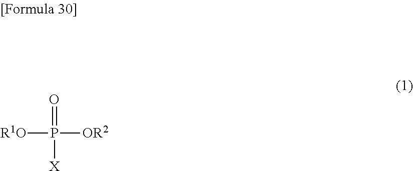

wherein R¹ and R² independently denote a substituted or nonsubstituted alkyl group having 1 to 18 carbon atoms, or a substituted or nonsubstituted aryl group; and X denotes a hydrogen atom or an alkyl group,
and phosphorous triesters represented by the formula (2):

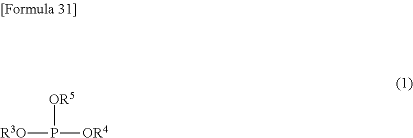

wherein R³ to R⁵ independently denote a substituted or nonsubstituted alkyl group having 1 to 18 carbon atoms, or a substituted or nonsubstituted aryl group;
and forming a positive electrode active material layer on a positive electrode current collector by using the positive electrode active material layer-forming liquid.

### Supplementary Note 25

A method for producing a positive electrode for a lithium secondary cell, comprising: forming a positive electrode active material layer comprising a positive electrode active material and a positive electrode binder on a positive electrode current collector; and soaking the positive electrode active material layer in a coating-forming liquid comprising at least one selected from phosphonic esters represented by the formula (1):

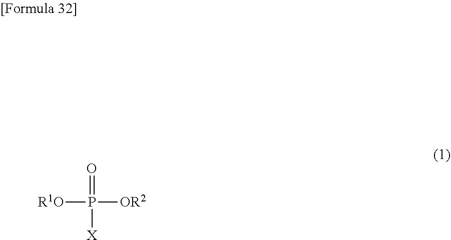

wherein R¹ and R² independently denote a substituted or nonsubstituted alkyl group having 1 to 18 carbon atoms, or a substituted or nonsubstituted aryl group; and X denotes a hydrogen atom or an alkyl group,
and phosphorous triesters represented by the formula (2):

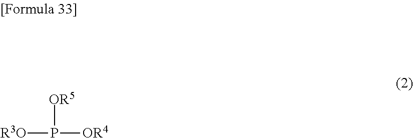

wherein R³ to R⁵ independently denote a substituted or nonsubstituted alkyl group having 1 to 18 carbon atoms, or a substituted or nonsubstituted aryl group;
or applying the coating-forming liquid onto the positive electrode active material layer, to form a coating on at least a part of the positive electrode active material for the sake of forming a coated positive electrode active material.

### Supplementary Note 26

A method for producing a lithium secondary cell, comprising: packing, in an outer package, a positive electrode comprising a positive electrode active material, a negative electrode comprising a negative electrode active material, a separator, and an electrolytic solution containing 0.05% by weight to 10% by weight of at least one selected from phosphonic esters represented by the formula (1):

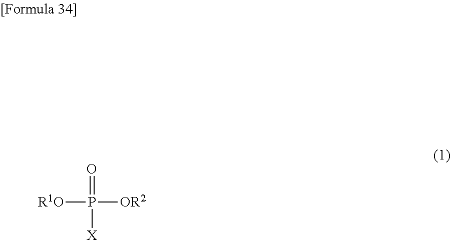

wherein R¹ and R² independently denote a substituted or nonsubstituted alkyl group having 1 to 18 carbon atoms, or a substituted or nonsubstituted aryl group; and X denotes a hydrogen atom or an alkyl group,
and phosphorous triesters represented by the formula (2):

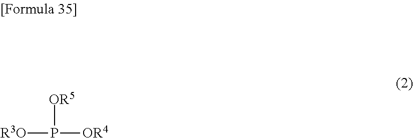

wherein R³ to R⁵ independently denote a substituted or nonsubstituted alkyl group having 1 to 18 carbon atoms, or a substituted or nonsubstituted aryl group;
sealing the outer package to form a sealed body; and thereafter, before an activation treatment, leaving the sealed body at room temperature to 80° C. to form a coating originated from the phosphonic ester represented by the formula (1) or the phosphorous triester represented by the formula (2) on at least a part of the surface of the positive electrode active material.

The present application includes all the contents described in Japanese Patent Application No. 2016-007743, filed on Jan. 19, 2016, as its content.

1.-10. (canceled)

11. A positive electrode active material for a lithium secondary cell, comprising a coated positive electrode active material having a coating comprising at least one selected from phosphonic esters represented by the formula (1): 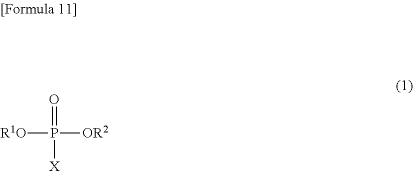
wherein R¹ and R² independently denote a substituted or nonsubstituted alkyl group having 1 to 18 carbon atoms, or a substituted or nonsubstituted aryl group; and X denotes a hydrogen atom or an alkyl group,
and phosphorous triesters represented by the formula (2): 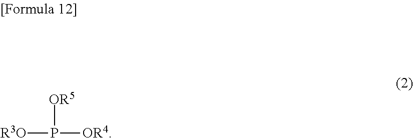
wherein R³ to R⁵ independently denote a substituted or nonsubstituted alkyl group having 1 to 18 carbon atoms, or a substituted or nonsubstituted aryl group, and
wherein the positive electrode active material comprises excess-lithium transition metal composite oxides represented by Li₁₊ₐNiₓMn_{y}M_{z}O₂ (0<a≤0.5, 0<x<1, 0<y<1, 0<z<1, and M is Co or Fe).

12. The positive electrode active material for a lithium secondary cell according to claim 11, wherein the positive electrode active material comprises a lithium transition metal composite oxide.

13. The positive electrode active material for a lithium secondary cell according to claim 11, wherein the positive electrode active material comprises at least one selected from LiMnO₂, LiₓMn₂O₄ (0<x<2), LiCoO₂, LiNiO₂, LiCo₁₋ₓNiₓO₂ (0.01<x<1), LiNiₓCo_{y}Mn_{z}O₂ (x+y+z=1), LiNi_{0.5}Mn_{1.5}O₄, Li_{α}Ni_{β}Co_{γ}Al_{δ}O₂ (1≤α≤1.2, β+γ+δ=1, β≥0.7, γ≤0.2), LiFePO₄, lithium transition metal composite oxides which comprise lithium in excessive amount to stoichiometric composition, and those obtained by replacing a part of these transition metals by another metal.

14. A positive electrode for a lithium secondary cell having, on a positive electrode current collector, a positive electrode active material layer comprising a positive electrode active material for a lithium secondary cell according to claim 11, and
wherein the positive electrode active material comprises excess-lithium transition metal composite oxides represented by Li₁₊ₐNiₓMn_{y}M_{z}O₂ (0<a≤0.5, 0<x<1, 0<y<1, 0<z<1, and M is Co or Fe).

15. A lithium secondary cell, comprising a positive electrode for a lithium secondary cell according to claim 14, a negative electrode comprising a negative electrode active material, an electrolytic solution penetrating these electrodes, and an outer package accommodating these.

16.-20. (canceled)
